(19) United States
(12) Patent Application Publication
(10) Pub. No.: US 2026/0291637 A1
(43) Pub. Date: Sep. 24, 2026

(54) Stretched single optical span communications system and method avoiding hazardous power levels

(71) Applicant: Ciena Corporation, Hanover, MD (US)

(72) Inventors: Kevan Peter Jones, Ottawa (CA); Vipul Bhatnagar, Kensington, MD (US); Marco Gaudet, Ottawa (CA); Francois Maurice Rheal Charron, Stittsville (CA)

(73) Assignee: Ciena Corporation, Hanover, MD (US)

(21) Appl. No.: 19/083,843

(22) Filed: Mar. 19, 2025

Related U.S. Application Data
(63) Continuation of application No. 18/075,847, filed on Dec. 6, 2022, now Pat. No. 12,278,693.

(51) Int. Cl. H04J 14/02; H04B 10/80

(52) U.S. Cl. CPC H04J 14/0297; H04B 10/807; H04J 14/0293

(57) ABSTRACT

An optical communication system is disclosed for transmission over a single optical fiber span exhibiting high loss of at least 40 dB. The system includes an optical transmitter configured to generate one or more optical signals using a high noise tolerant optical modulation format. Specifically, the modulation format is coherent modulation operating at a baud rate of at least 35 GBaud and requiring an Optical Signal-to-Noise Ratio (OSNR) below 14 dB. The system further comprises an Erbium Doped Fiber Amplifier (EDFA) booster, which amplifies the optical signals to a launch power level below hazardous optical power thresholds, and a pre-amplifier, also an EDFA, configured to amplify the optical signals received from the fiber span. Advantageously, the disclosed system eliminates the need for Raman amplification, enabling safe and efficient transmission over extended single-span distances.

### CROSS-REFERENCE TO RELATED APPLICATIONS

The present disclosure is a continuation of U.S. patent application Ser. No. 18/075,847, filed Dec. 6, 2022, the contents of which are incorporated by reference in their entirety.

### FIELD OF THE DISCLOSURE

The present disclosure relates generally to optical networking. More particularly, the present disclosure relates to systems and methods for a stretched single optical communication span, avoiding hazardous power levels.

### BACKGROUND OF THE DISCLOSURE

Classic applications for single span systems in fiber optics can include festoon systems, channel crossings, terrestrial systems such as in remote areas (e.g., jungle, desert, etc.), and the like. In general terms in fiber optics, single span systems up to 35-45 dB may be supported using conventional amplification solutions. To go beyond these high single span losses (40 dB @ 0.2 dB/km equates to a 200 km single span) distributed amplification solutions are usually deployed. They usually start with counter-propagating distributed Raman amplification that uses the deployed system fiber for optical gain, but the most extreme links (beyond 50 dB) will often also use co-propagating Raman also and even Remote Optically Pumped Amplifiers (ROPA). ROPAs are achieved by embedding a passive (no electrical power required) amplifier stage in the optical cable some distance from the Terminal and then using the primary (and/or) other fibers to deliver an optical pump signal to the erbium doped fiber at the ROPA. In all the above cases (counter-Raman, co-Raman and ROPA) high optical power sources (500 mW to multi-W) are required at the Terminal site.

High Optical Power solutions including counter-Raman, co-Raman and ROPA operate at potentially dangerous power levels and so must include automatic safety systems for acceptable deployment. These systems typically include an ALSO (Automatic Laser Shut Off) system to reduce the power of the lasers to a safe level when a system fault (e.g., fiber break or disconnect) is detected. These safety systems increase the complexity and cost of the product. Furthermore, the high optical powers are at such a level that they can cause damage to the system fiber plant, particularly when high local losses are encountered. This can cause local heating and damage to the fibers and connectors. Therefore, the optical safety systems must also protect the system equipment, as well as users, from optical damage. This further complicates the safety system and often requires additional instrumentation (e.g., Optical Time Domain Reflectometers—OTDR) to identify concerns and assess the risk to system turn up. When encountering such fiber plant problems, the systems can be difficult to turn up and require expert operators to resolve the issue and/or cause customer frustration.

### BRIEF SUMMARY OF THE DISCLOSURE

The present disclosure relates to systems and methods for a stretched single optical communication span, avoiding hazardous power levels. Specifically, the present disclosure provides a simplified approach to configure conventional off-the-shelf Erbium Doped Fiber Amplifiers (EDFAs) to provide a stretched single span communication system, without resorting to high power solutions such as distributed Raman amplification or remotely pumped amplifiers or specialized amplifier designs for high-loss spans. This allows for simple deployment in eye-safe configurations (Class 1 Hazard 1M) using low cost, low power equipment.

In an embodiment, a method of implementing a stretched single optical communication span includes receiving one or more optical signals from an optical fiber span having high loss; adding a pilot signal to the one or more optical signals, subsequent to the receiving; and amplifying the one or more optical signals and the pilot signal with a pre-amplifier that is an Erbium Doped Fiber Amplifier (EDFA). The method can further include demodulating the one or more optical signals subsequent to the amplifying. The or more optical signals can include a high noise tolerant optical modulation format. The high noise tolerant optical modulation format can be 100 Gbps Quadrature Phase Shift Keying (QPSK) using a 56 GBaud signal.

The stretched single optical communication span can operate below a Hazard 1M environment. A received power of the one or more optical signals can be less than −30 dBm. The EDFA can operate in a gain-controlled mode and is configured to shut off after a low input power. The low input power can be about −30 dBm. The high loss can be at least 40 dB. The method can further include monitoring separately a power of the one or more optical signals and the pilot signal. The one or more channels can include at least four channels. The pilot signal has spectrum located within an amplification bandwidth of the EDFA. The pilot signal can be formed by a local transmitter that is one of a laser and an Amplified Spontaneous Emission (ASE) source.

In another embodiment, a node in a stretched single optical communication span includes an optical multiplexer connected to an optical fiber span having high loss and a pilot signal, and configured to output a combination of one or more optical signals from the optical fiber span and the pilot signal; and a pre-amplifier that is an Erbium Doped Fiber Amplifier (EDFA), configured to receive the output of the optical multiplexer and provide amplification of the one or more optical signals and the pilot signal.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a conventional single span optical system.

FIG. 2 is a diagram of a single span optical system according to an embodiment of the present disclosure.

FIG. 3 is a flowchart of a process for operating a single span optical system according to an embodiment of the present disclosure.

FIG. 4 is a diagram of an experimental setup illustrating results utilizing the present disclosure.

### DETAILED DESCRIPTION OF THE DISCLOSURE

The present disclosure relates to systems and methods for a stretched single optical communication span, avoiding hazardous power levels. Specifically, the present disclosure provides a simplified approach to configure conventional off-the-shelf Erbium Doped Fiber Amplifiers (EDFAs) to provide a stretched single span communication system, without resorting to high power solutions such as distributed Raman amplification or remotely pumped amplifiers or specialized amplifier designs for high-loss spans. This allows for simple deployment in eye-safe configurations (Class 1 Hazard 1M) using low cost, low power equipment.

Generally, the present disclosure includes (1) use of a high noise tolerant optical modem, (2) conventional EDFAs that are “off-the-shelf” and within the Class 1 Hazard 1M limits, and (3) a technique at the receiver pre-amplifier to ensure the conventional EDFA operates in a gain control mode despite receiving extremely low-powered input signals.

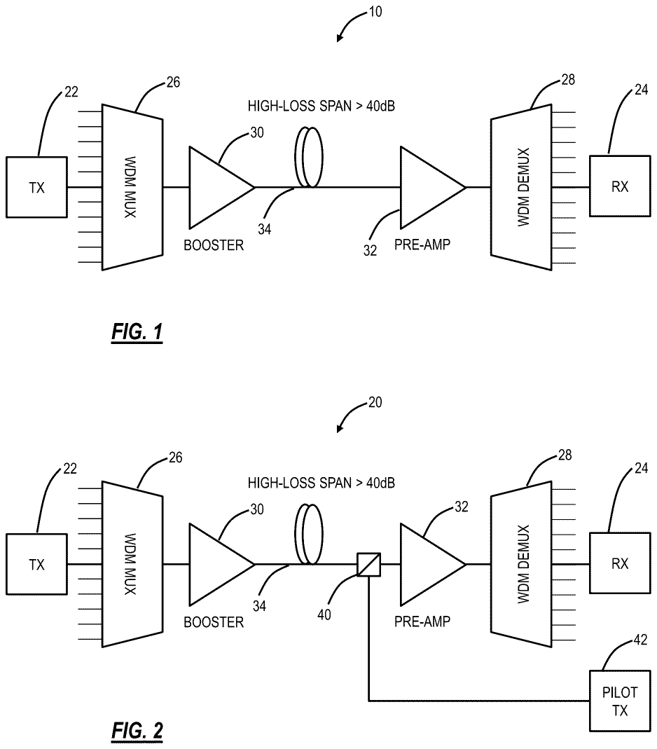

FIG. 1 is a diagram of a conventional single span optical system 10. FIG. 2 is a diagram of a single span optical system 20 according to an embodiment of the present disclosure. Both FIGS. 1 and 2 are illustrated in a unidirectional configuration, from left to right. Also, FIGS. 1 and 2 are illustrated with a single channel (transmitter TX 22 and receiver RX 24). Those skilled in the art will recognize practical implementations can include a second set of equipment for bidirectional communications and there can be more than one channel, such as using Wavelength Division Multiplexing (WDM). The optical systems 10, 20 can include a WDM multiplexer (mux) 26 and WDM demultiplexer (demux) 28, for WDM.

The optical systems 10, 20 also include a booster amplifier 30, i.e., a conventional EDFA, and also known as a post amplifier. The booster amplifier 30 is located after the TX 22 and the WDM multiplexer 26. The optical systems 10, 20 also include a pre-amplifier 32, i.e., another conventional EDFA. The pre-amplifier 32 is located before the WDM demultiplexer 28 and the RX 24, and after a fiber span 34. In the present disclosure, the fiber span 34 is a high-loss span, such as having a loss in excess of 40 dB or the like.

The pre-amplifier 32 can have a gain of G dB and the output power of the pre-amplifier 32 is as follows:

$${P}_{out} = {P}_{sig , out} + {P}_{ASE , out}$$

Where the P_{sig,out} is the output power of any optical signals, and P_{ASE,out} is the output power of noise from the pre-amplifier 32, i.e., Amplified Spontaneous Emission (ASE) noise. Unfortunately, the pre-amplifier 32 EDFA gain control is difficult to manage when P_{sig,out}«P_{ASE,out} which is the case due to the high-loss span.

Again, in FIG. 2, the present disclosure utilizes
(1) high noise tolerant optical modems,
(2) conventional EDFAs that are “off-the-shelf” and within the Class 1 Hazard 1M limits, and
(3) a technique at the receiver pre-amplifier to ensure the conventional EDFA operates in a gain control mode despite receiving extremely low-powered input signals, namely a channel idler input to the pre-amplifier 32.

Advantageously, this approach meets requirements for extended span support, but in a way that is simple and low cost to deploy. This extends the reach of non-Raman systems by >10 dB and allows for easier to deploy systems that still meet the Hazard 1M safety requirement. Of significance, the high-loss span is typically located in remote areas, where it is difficult to reach, and this low cost and simple approach is beneficial for network operators.

### High Noise Tolerant Optical Modems and Conventional EDFAs

The present disclosure uses the properties of a high noise tolerant coherent transceiver or modem system in combination with conventional Hazard 1M EDFAs to deliver a solution that is easy to turn up with no concerns for user, equipment or fiber plant safety.

Examples of high noise tolerant coherent modems include a 100 Gbps Quadrature Phase Shift Keying (QPSK) using a 56 GBaud signal, 100 Gbps Quadrature Phase Shift Keying (QPSK) using a 35 GBaud signal, 200 Gbps QPSK using a 63 Gbaud signal, and the like, i.e., having a high Required Optical Signal-to-Noise Ratio (ROSNR), such as 14 dB, as well as any coherent modulation scheme that uses sufficient Forward Error Correction (FEC) coding gain to only require a lower OSNR to recover the signal, e.g., <14 dB.

A high performance, high noise tolerant coherent modem, such as a 100 Gbps QPSK 56 GBaud transceiver, would typically have a TX power of up to +4 dBm and a minimum Rx power of −20 dBm. This would deliver an unamplified link budget of ~24 dB.

The TX 22 can be boosted by a head-end booster amplifier 30 to (say) +14 dBm, increasing the link budget to ~34 dB.

To achieve additional reach, the pre-amplifier 32 can be used at the tail end of the system 20. With an operating input power of (say)-30 dBm the pre-amplifier increases the link budget to ~44 dB. This is not limited by the required Signal-to-Noise Ratio (SNR) delivered to transceiver, but rather by the pre-amplifier's operating powers.

To facilitate ease of adding additional WDM channels both the booster amplifier 30 and the pre-amplifier 32 are operated in gain control mode. For many EDFAs, a Loss of Signal (LOS) shutdown system is included that turns the amplifier 30, 32 off when the input falls too low. This is often set to a threshold of about −30 dBm. This is included as when the input falls too low, the gain control of the EDFA becomes inaccurate and is largely controlling on the ASE output of the EDFA, this effectively turns the amplifier into a power-controlled device, rather than a gain controlled device. Whilst this is OK for single channel operation, it is less ideal for a multi-channel WDM where a constant gain is preferred to maintain channel independence.

### Channel Idler

To provide constant gain, the present disclosure includes use of an optical mux 40 at the tail end of the system 20 (before the pre-amplifier 32), configured to provide a pilot signal locally to the pre-amplifier 32. This pilot signal may be generated from another optical source and can be a laser or even an ASE source, e.g., from a pilot TX 42. This then becomes the primary signal that determines the gain control of the pre-amplifier 32 and then the pre-amplifier 32 will provide uniform (does not change with loading) gain as additional very low power WDM channels are added. This technique allows for simple, conventional EDFAs to be used at constant gain with low operating signal powers without triggering LOS shut-down.

The optical mux 40 may be further enhanced with individual input power monitors to separately measure the incoming signal and the pilot signal. The optical mux 40 may be implemented as either a power combiner or a filter. The pilot TX 42 needs to have a wavelength or range of spectrum that (1) does not interfere with any channels in the system 20, and (2) that is within the amplification bandwidth of the pre-amplifier 32, i.e., about 1530-1565 nm). In an embodiment, the pilot TX 42 can be a non-used TX 22 as well as a dedicated source. The optical mux 40 may be packaged either external to the EDFA module or integrated within the EDFA module, where the EDFA module is for the pre-amplifier 32.

In the context of the high noise tolerant coherent modem, this allows the amplifiers 30, 32 to be operated simply whilst supporting greater spans losses, that can be increased up to the SNR limit of the transceiver. In many cases, this will allow >10 dB of additional link budget to be supported before the SNR limit is achieved. Our simulation and testing has shown this can allow for 55-60 dB of link budget support to be achieved.

The head end powers of the system 20 dictate the safety classification and (for example) with a nominal launch power of ~14 dBm, it is possible to support four WDM channels into total and still stay within the <21 dBm limit required for Hazard 1M.

Using this method we can achieve >55 dB link budget support using simple Hazard 1M EDFA and operating in Gain control to allow for simple traffic addition up to 4 WDM channels. This provides a strong transmission capability (400 Gbps) over high-loss (>55 dB) links without requiring user or equipment safety systems.

### Process

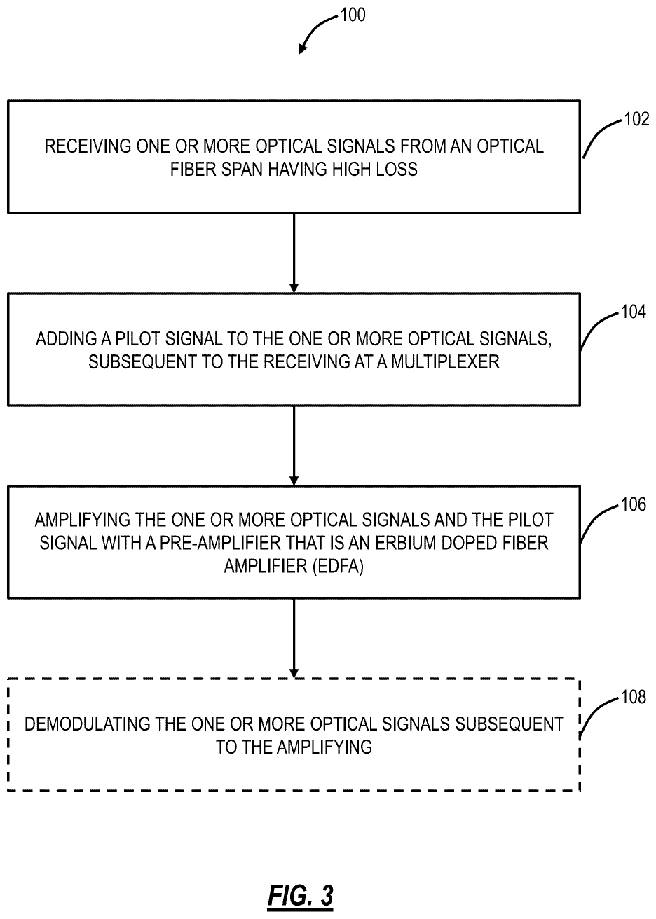

FIG. 3 is a flowchart of a process 100 for operating a single span optical system according to an embodiment of the present disclosure. The process 100 includes receiving one or more optical signals from an optical fiber span having high loss (step 102); adding a pilot signal to the one or more optical signals, subsequent to the receiving (step 104); and amplifying the one or more optical signals and the pilot signal with a pre-amplifier that is an Erbium Doped Fiber Amplifier (EDFA) (step 106). The process 100 can include demodulating the one or more optical signals subsequent to the amplifying, i.e., subsequent to the receiving at the multiplexer 40 (step 108).

The one or more optical signals can include a high noise tolerant optical modulation format. For example, the high noise tolerant optical modulation format can be 100 Gbps Quadrature Phase Shift Keying (QPSK) using a 56 GBaud signal. The stretched single optical communication span operates below a Hazard 1M environment. A power of the one or more optical signals can be less than −30 dBm. The EDFA operates in a gain controlled mode and is configured to shut off after a low input power. The low input power can be about −30 dBm.

The high loss can be at least 40 dB. The process 100 can include monitoring separately a power of the one or more optical signals and the pilot signal. The one or more channels can include at least four channels. The pilot signal can have spectrum located within an amplification bandwidth of the EDFA. The pilot signal can be formed by a local transmitter that is one of a laser and an Amplified Spontaneous Emission (ASE) source.

In another embodiment, a node in a stretched single optical communication system 20 includes an optical multiplexer 40 connected to an optical fiber span 34 having high and a pilot signal, and configured to output a combination of one or more optical signals from the optical fiber span and the pilot signal; and a pre-amplifier 32 that is an Erbium Doped Fiber Amplifier (EDFA), configured to receive the output of the optical multiplexer and provide amplification of the one or more optical signals and the pilot signal.

The node can further include one or more receivers 34 configured to demodulate the one or more optical signals subsequent to the amplification. The one or more optical signals can include a high noise tolerant optical modulation format.

The stretched single optical communication span operates below a Hazard 1M environment. A received power of the one or more optical signals is less than −30 dBm. The EDFA operates in a gain-controlled mode and is configured to shut off after a low input power. The high loss is at least 40 dB.

### Test/Experimental Setup and Results

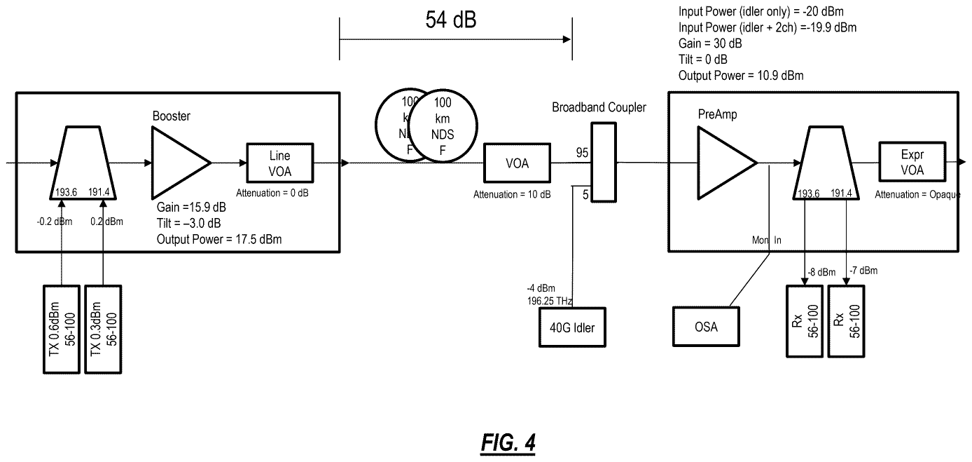

FIG. 4 is a diagram of an experimental setup illustrating results utilizing the present disclosure. The experimental setup includes two transmitters, each being a 100 Gbps QPSK at 56 Gbaud, and having frequencies of 193.6 THz and 191.4 THz. This is 200 Gbps total and the two multiplexed wavelengths are boosted by a conventional EDFA (post-amplifier) to provide an output power of 17.5 dBm.

The span is set to 54 dB loss which is based on 200 km of Non-Dispersion Shifted Fiber (NDSF) in addition to a Variable Optical Attenuator (VOA) set at 10 dB. After the span, there is a broadband coupler that combines an idler channel (the pilot Tx 42), in this case a 40 Gbps signal, with the two multiplexed wavelengths. The combination of signals is provided to a preamplifier 32 with a gain of about 30 dB. The idler channel has an output power of −4 dBm, such that the input power to the preamplifier 32 is −20 dBm for just the idler channel and −19.9 dBm for the idler channel plus the two multiplexed wavelengths.

Finally, the two multiplexed wavelengths are demultiplexed and demodulated with a power of −8 dBm and −7 dBm, respectively.

The following results were seen including Optical Signal-to-Noise Ratio (OSNR) from an Optical Spectrum Analyzer (OSA) and other data from Performance Monitoring (PM) data associated with the modem (Rx).

| Parameter | 193.6 | | 191.4 | | Comment |
|---|---|---|---|---|---|
| OSNR | 14.2 | | 15.28 | | From OSA |
| Total Input Power | −7.0 | | −6.8 | | Modem PM |
| Channel Rx Power | −8.0 | | −7.0 | | Modem PM |
| Rx Chromatic Dispersion | 1745/3481 | | 1857/3707 | | Modem PM |
| preFEC BER | 2.9E−03 | | 1.2E−03 | | Modem PM |
| Qavg | 8.8 | dBQ | 9.65 | dBQ | Modem PM |
| SNRext | 6.04 | dB | 6.92 | dB | Modem PM |
| ESNR | 5.71 | dB | 6.53 | dB | Modem PM |

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. An optical communication system over a single optical fiber span with high loss of at least 40 dB, comprising:
an optical transmitter configured to generate one or more optical signals using a high noise tolerant optical modulation format, wherein the high noise tolerant optical modulation format comprises coherent modulation with a baud rate of at least 35 GBaud and a required Optical Signal-to-Noise Ratio (OSNR) of less than 14 dB;
an Erbium Doped Fiber Amplifier (EDFA) booster configured to amplify the one or more optical signals to a launch power into the single optical fiber span below hazardous optical power levels and
a pre-amplifier comprising an EDFA configured to amplify received optical signals from the single optical fiber span, wherein the optical communication system operates without Raman amplification.

2. The optical communication system of claim 1, wherein the coherent modulation has a data rate of at least 100 Gbps.

3. The optical communication system of claim 1, wherein the coherent modulation has a baud rate of 56 GBaud.

4. The optical communication system of claim 1, wherein the coherent modulation has a baud rate of 63 GBaud.

5. The optical communication system of claim 1, wherein the received optical power at the pre-amplifier is less than or equal to −30 dBm.

6. The optical communication system of claim 1, wherein the pre-amplifier operates in a gain-controlled mode configured to maintain stable gain despite input signals at or below −30 dBm.

7. The optical communication system of claim 1, wherein the optical communication system maintains operation below Class 1 Hazard 1M optical safety level.

8. The optical communication system of claim 1, further comprising an optical multiplexer configured to combine multiple wavelength division multiplexed (WDM) channels.

9. The optical communication system of claim 8, wherein the WDM channels include at least four optical channels.

10. The optical communication system of claim 1, wherein the EDFA booster amplifies optical signals to a launch power not exceeding approximately +14 dBm.

11. A method for optical communication across a stretched single span having high loss of at least 40 dB, comprising:
transmitting optical signals utilizing a high noise tolerant optical modulation format comprising coherent modulation at a baud rate of at least 35 GBaud with a required Optical Signal-to-Noise Ratio (OSNR) of less than 14 dB, at power levels within Class 1 Hazard 1M safety limits; and
amplifying the optical signals using a conventional Erbium Doped Fiber Amplifier (EDFA), without distributed Raman amplification or remotely pumped amplifiers, wherein the optical signals maintain adequate signal quality for demodulation after amplification.

12. The method of claim 11, wherein the coherent modulation has a data rate of at least 100 Gbps.

13. The method of claim 11, wherein the coherent modulation has a baud rate of 56 GBaud.

14. The method of claim 11, wherein the coherent modulation has a baud rate of 63 GBaud.

15. The method of claim 11, wherein the optical signals are received at a power level of less than or equal to −30 dBm at the conventional EDFA.

16. The method of claim 11, further comprising operating the EDFA in gain-controlled mode at low input powers below −30 dBm, thereby avoiding EDFA shutdown due to low input power.

17. The method of claim 11, wherein optical signals are transmitted with a launch power not exceeding approximately +14 dBm.

18. An optical network node configured for optical communications over a single fiber span having high loss of at least 40 dB, comprising:
an optical multiplexer configured to combine optical communication signals each using one or more high noise tolerant optical modulation formats with each including coherent modulation with a baud rate of at least 35 GBaud and a required Optical Signal-to-Noise Ratio (OSNR) of less than 14 dB; and
an Erbium Doped Fiber Amplifier (EDFA) booster configured to amplify the optical communication signals to a launch power into the fiber span below hazardous optical power levels.

19. The optical network node of claim 18, wherein the EDFA booster amplifies the optical communication signals to a launch power not exceeding approximately +14 dBm.

20. The optical network node of claim 18, wherein the single fiber span does not include Raman amplification.
